(19) United States
(12) Patent Application Publication
(10) Pub. No.: US 2007/0180433 A1
(43) Pub. Date: Aug. 2, 2007

(54) Method to enable accurate application packaging and deployment with optimized disk space usage

(75) Inventors: Shereen Makram Ghobrial, Richmond Hill (CA); Nelson Jean, Markham (CA); Patrick S.C. Tiu, Markham (CA); Sean Zhou, Toronto (CA)

Correspondence Address: DUKE W. YEE, YEE & ASSOCIATES, P.C., P.O. BOX 802333, DALLAS, TX, 75380, US

(73) Assignee: International Business Machines Corporation, Armonk, NY (US)

(21) Appl. No.: 11/340,879

(22) Filed: Jan. 27, 2006

(51) Int. Cl. G06F 9/45

(52) U.S. Cl. 717/136

(57) ABSTRACT

A computer implemented method, apparatus, and computer program product for generating a customized dependency library for use by an application. Execution of the application is monitored. Each dependency used by the application is identified during execution of the application. A customized dependency library is generated for the application containing only the dependencies used by the application.

### BACKGROUND OF THE INVENTION

1. Field of the Invention

The present invention relates generally to data processing, and in particular to a computer implemented method, apparatus, and computer program product for generating a customized dependency library.

2. Description of the Related Art

Developers use frameworks for application development. A framework is a defined structure in which another software project can be organized and developed effectively allowing the different components of an application to be integrated. These frameworks typically include architecture and an application programming interface (API). Java™ 2 Platform, Enterprise Edition (J2EE) is an example framework from Sun Microsystems for building distributed enterprise applications. J2EE™ is a Java™-based runtime platform for developing, deploying, and managing distributed multi-tier architectural applications using modular components.

In J2EE™ programming mode, tools are provided to seamlessly develop, assemble, and deploy a client application, which may then be launched from client systems and communicate with J2EE™ servers. The client application usually needs a number of libraries to gain the capability to communicate with a server. Depending upon how complicated the client application is and how many J2EE™ functions the client application implements, the required number of libraries may vary significantly. Moreover, in each library, a client application may use most of the client application's classes, but another client application may only need a small portion of the application's classes in the library.

As the J2EE™ programming mode evolves forward adding new technologies, the size of a complete set of libraries has grown dramatically. To J2EE™ client application developers or deployers, there is always a strong need for tools that can help them identify a required library from the full set of libraries, so that they can package client applications with smaller footprints and easily deploy the client application. This need is even more important when the client applications are deployed in footprint restricted environments such as a personal digital assistant (PDA), cell phone, or low disk space desktops.

In one possible solution, J2EE™ software providers include a full set of libraries and require the client application developers to deploy their client applications with the full set of libraries. This solution does not work well for customers with restricted computing power environments such as PDA's or cell phones.

In another alternative, J2EE™ software providers provide a library with all required classes for a specific type of client applications. This alternate is rigid because it is limited to most commonly used applications with general library needs. Additionally, the client application may be forced to add new functions and corresponding libraries resulting in a large footprint.

In yet another alternative, a set of libraries may be selected for a client application by employing a trial-and-error manual process. The trial-and-error process involves selecting a minimum number of libraries and expanding as needed until the client application runs without any errors. Using trial-and-error may be very time consuming and error-prone. This type of solution may only eliminate libraries that are not required by the client application, while the included libraries may still have redundant contents.

### BRIEF SUMMARY OF THE INVENTION

The aspects of the present invention provide a computer implemented method, apparatus, and computer program product for generating a library for use by an application. Execution of the application is monitored. Each class used by the application is identified during execution of the application. A specific library is generated for the application containing only the classes used by the application.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is pictorial representation of a data processing system in which the aspects of the present invention may be implemented;

FIG. 2 is a block diagram of a data processing system in which aspects of the present invention may be implemented;

FIG. 3 is a block diagram of a dependency packaging system in accordance with an illustrative embodiment of the present invention;

FIG. 4 is a flow diagram of a dependency packaging system in accordance with an illustrative embodiment of the present invention;

FIG. 5 is a dependency list in accordance with an illustrative embodiment of the present invention;

FIG. 6 is a pictorial representation of a dependency packaging system before and after implementing the processes in accordance with an illustrative embodiment of the present invention; and

FIG. 7 is a flowchart of a process for dependency packaging in accordance with an illustrative embodiment of the present invention.

### DETAILED DESCRIPTION OF THE INVENTION

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects all generally referred to herein as a “circuit” or “module.” Furthermore, the present invention may take the form of a computer program product on a computer-usable storage medium having computer usable program code embodied in the medium.

Any suitable computer useable or readable medium may be utilized. The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Computer program code for carrying out operations of the present invention may be written in an object oriented programming language such as Java™, Smalltalk or C++. However, the computer program code for carrying out operations of the present invention may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

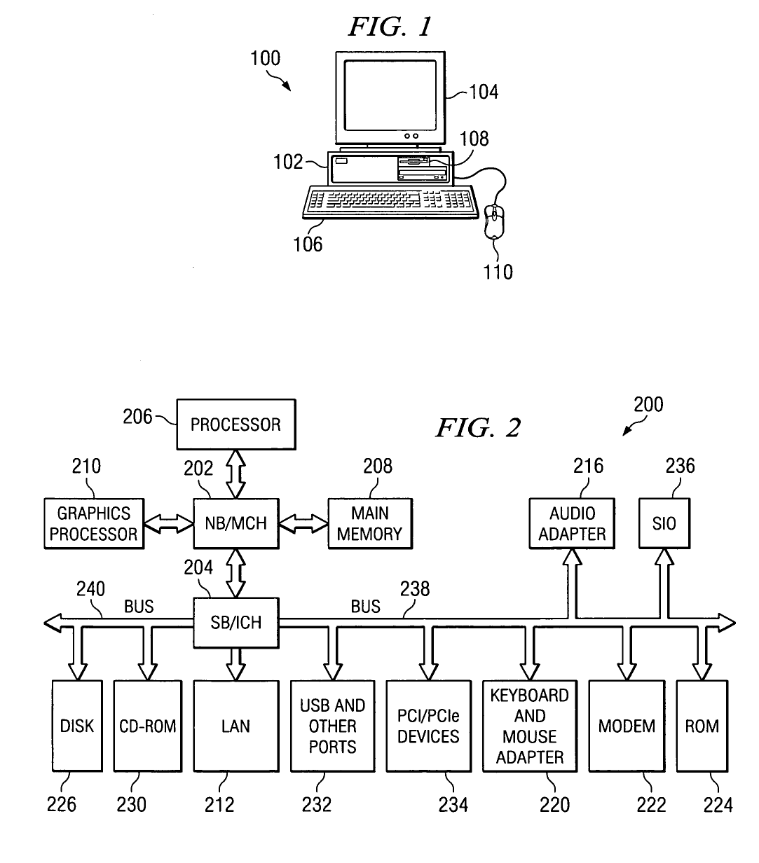

With reference now to the figures and in particular with reference to FIG. 1, a pictorial representation of a data processing system in which the aspects of the present invention may be implemented. A computer 100 is depicted which includes system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like.

Computer 100 can be implemented using any suitable computer, such as an IBM eServer computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface (GUI) that may be implemented by means of systems software residing in computer readable media in operation within computer 100.

With reference now to FIG. 2, a block diagram of a data processing system is shown in which aspects of the present invention may be implemented. Data processing system 200 is an example of a computer, such as computer 100 in FIG. 1, in which code or instructions implementing the processes of the present invention may be located. In the depicted example, data processing system 200 employs a hub architecture including a north bridge and memory controller hub (MCH) 202 and a south bridge and input/output (I/O) controller hub (ICH) 204. Processor 206, main memory 208, and graphics processor 210 are connected to north bridge and memory controller hub 202. Graphics processor 210 may be connected to the MCH through an accelerated graphics port (AGP), for example.

In the depicted example, local area network (LAN) adapter 212 connects to south bridge and I/O controller hub 204 and audio adapter 216, keyboard and mouse adapter 220, modem 222, read only memory (ROM) 224, hard disk drive (HDD) 226, CD-ROM drive 230, universal serial bus (USB) ports and other communications ports 232, and PCI/PCIe devices 234 connect to south bridge and I/O controller hub 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be connected to south bridge and I/O controller hub 204 through bus 238.

An operating system runs on processor 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java™ programs or applications executing on data processing system 200 (Java is a trademark of Sun Microsystems, Inc. in the United States, other countries, or both).

Instructions for the operating system, the object-oriented programming system, and applications or programs are located on storage devices, such as hard disk drive 226, and may be loaded into main memory 208 for execution by processor 206. The processes of the present invention are performed by processor 206 using computer implemented instructions, which may be located in a memory such as, for example, main memory 208, read only memory 224, or in one or more peripheral devices.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the present invention may be applied to a multiprocessor data processing system.

In some illustrative examples, data processing system 200 may be a personal digital assistant (PDA), which is configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

The aspects of the present invention provide a computer implemented method, apparatus, and computer program product for generating a customized dependency library. Embodiments of the present invention provide a profiler or profiling tool that is used to monitor the execution of a client application and record all of the dependencies used during execution. Dependencies refer to all libraries, files, classes, objects, scripts, sections of program code, or other elements relied upon during execution of all scenarios and functionality of the application.

Once all desired user scenarios have been executed by the client application, the profiling tool extracts the dependencies used by the client application and generates a customized dependency library. The process of customizing a dependency library may occur during development of the client application. As a result, the client application may be deployed with a single customized dependency library to other client systems without installing a full dependency library.

Memory and processing resources are conserved because a client device stores only the customized dependency library instead of the full dependency library. Only dependencies that are required for successful operation of the client application are packaged in the customized dependency library eliminating many portions of the dependency library entirely and selecting only needed portions of other aspects of the dependency library.

Embodiments of the present invention may be applied to client applications operating using any number of programming languages. Illustrative embodiments may be directed toward Java™ embodiments, these embodiments are not meant as technical or specified limitations.

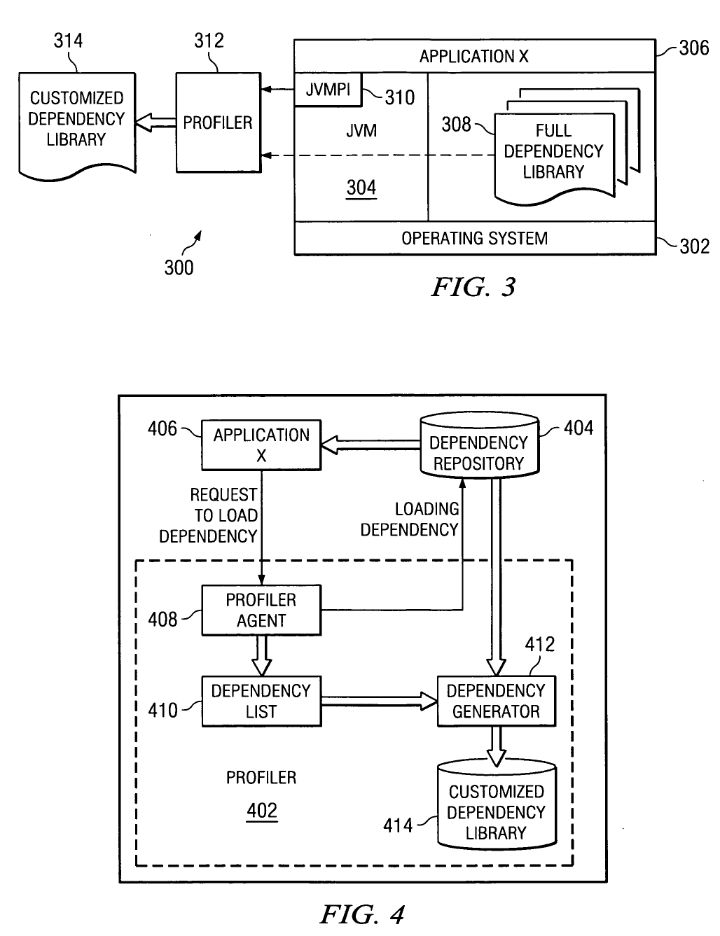

FIG. 3 is a block diagram of a dependency packaging system in accordance with an illustrative embodiment of the present invention. FIG. 3 illustrates the relationships of various software components within a computer system that may be used to create a customized dependency library.

Java™-based system 300 contains platform specific operating system 302 that provides hardware and system support to software executing on a specific hardware platform. Java virtual machine 304 is one software application that may execute in conjunction with the operating system. Java virtual machine 304 provides a Java run-time environment with the ability to execute application X 306, which in these illustrative examples is a program, servlet, or software component written in the Java™ programming language. The computer system in which Java virtual machine 304 operates may be similar to data processing system 200 of FIG. 2 or computer 100 in FIG. 1. However, Java virtual machine 304 may be implemented in dedicated hardware on a so-called Java™ chip, Java™-on-silicon, or Java™ processor with an embedded picoJava™ core.

At the center of a Java™ run-time environment is Java virtual machine 304, which supports all aspects of Java's™ environment, including its architecture, security features, mobility across networks, and platform independence.

Java virtual machine 304 is a virtual computer, for example a computer that is specified abstractly. The specification defines certain features that every Java virtual machine implements, with some range of design choices that may depend upon the platform on which Java virtual machine 304 is designed to execute. For example, all Java virtual machines execute Java™ bytecodes and may use a range of techniques to execute the instructions represented by the bytecodes. Java virtual machine 304 may be implemented completely in software or software and hardware. This flexibility allows different Java virtual machines to be designed for mainframe computers, cell phones, personal digital assistants (PDAs), or other computing devices.

Java virtual machine 304 is the name of a virtual computer component that actually executes Java™ programs. Java™ programs are not run directly by the central processor but instead by Java virtual machine 304, which is itself a piece of software running on the processor. Java virtual machine 304 allows Java™ programs to be executed on a different platform as opposed to only the one platform for which the code was compiled. Java™ programs are compiled for the Java virtual machine 304. In this manner, Java™ is able to support applications for many types of data processing systems, which may contain a variety of central processing units and operating systems architectures. To enable a Java™ application to execute on different types of data processing systems, a compiler typically generates an architecture-neutral file format the compiled code is executable on many processors, given the presence of the Java™ run-time system. The Java™ compiler generates bytecode instructions that are nonspecific to a particular computer architecture.

Bytecode instructions may be executed regardless of the processor architecture used to execute the bytecode. The bytecode does not need to be native to the processor processing the bytecode instructions. A bytecode is a machine independent code generated by the Java™ compiler and executed by a Java™ interpreter. A Java™ interpreter is part of Java virtual machine 304 that alternately decodes and interprets a bytecode or bytecodes. These bytecode instructions are designed to be easy to interpret on any computer and easily translated on the fly into native machine code. Bytecodes are may be translated into native code by a just-in-time compiler or JIT.

Java virtual machine 304 loads class files from full dependency library 308 and executes the bytecodes within them. Full dependency library 308 may include one or more third party runtime libraries. For example, in a J2EE™ client application, full dependency library 308 may include a J2EE™ application programming interface (API) and implementation library named J2EE.jar, message client API named message.jar, and a database vendor specific data source implementation library named dbclient.jar.

The class files are loaded by a class loader in the Java virtual machine 304. The class loader loads class files from application X 306 and the class files from the Java™ application programming interfaces which are needed by the application X 306. The execution engine that executes the bytecodes may vary across platforms and implementations.

When an application such as application X 306, is executed on a Java virtual machine that is implemented in software on a platform-specific operating system, application X 306 may interact with the host operating system by invoking native methods. A Java™ method is written in the Java™ language, compiled to bytecodes, and stored in class files. A native method is written in some other language and compiled to the native machine code of a particular processor. Native methods are stored in a dynamically linked library whose exact form is platform specific. In the present invention all dependencies, including Java™ methods and native methods, that may be used by application X 306 are stored in full dependency library 308.

Java virtual machine 304 may also include a Java virtual machine profiler interface (JVMPI) 310. Java virtual machine profiler interface 310 may be used to communicate with profiler 312. Profiler 312 monitors and records various events that occur within Java virtual machine 304 using Java virtual machine profiler interface 310. Profiler 312 is a monitoring and recording component that observes and records various events within Java virtual machine 304. For example, profiler 312 through Java virtual machine profiler interface 310, catches the class load events as Java virtual machine 304 loads necessary classes from full dependency library 308 for execution of application X 306. Profiler 312 monitors the entire execution lifecycle of application X 306 through all scenarios, logging each new class in a metadata file as the class is loaded by Java virtual machine 304. Profiler 312 may be used during development of application X 306 logging each new class used as informed by Java virtual machine profiler interface 310.

When application X 306 has run through all possible scenarios, profiler 312 uses the logged metadata file logged to extract all the classes used by application X 306. Profiler 312 packages all of the extracted classes into customized dependency library 314. Customized dependency library 314 is a single library optimized to only include the classes used by application X 306. For example, customized dependency library 314 may be a single jar file that is much smaller in size than full dependency library 308.

For example, although the depicted embodiment is directed towards processing bytecodes in Java™, the processes of the present invention also may be applied to other programming languages and environments that process instructions, which are nonspecific to a computer on which the instructions are to be executed. In such a case, a virtual machine on the computer may interpret the instructions or send the instructions to a compiler to generate code suitable for execution by the computer on which the virtual machine is located.

FIG. 4 is a flow diagram of a dependency packaging system in accordance with an illustrative embodiment of the present invention. Profiler 402 may be a profiler such as profiler 312 of FIG. 3. Dependency repository 404 houses all of the dependencies, such as full dependency library 308 of FIG. 3, which may be used when running application X 406. As application X 406 runs through all possible scenarios, profiler agent 408 is a profiling component used to monitor and record all request to load dependencies from dependency repository 404 to application X 406. Profiler agent 408 may record each new dependency or class in dependency list 410.

Dependency list 410 may be a metadata file, list, record, or other identification indicating and identifying dependencies of an application. Dependencies may be identified or listed by name, call, location, or other identifying feature. Once application X 406 has run through all possible scenarios, dependency generator 412 uses dependency list 410 to extract all necessary dependencies from dependency repository 404. As a result, only relevant dependencies within dependency repository 404 are extracted.

Dependency generator 412 uses dependencies listed in dependency list 410 and extracted from dependency repository 404 to generate a customized dependency library 414 or specific library. In the illustrative examples, customized dependency library 414 may be a single library or dependency file housing all of the dependencies used for application X 406. As described, application X 406 may be deployed with a single library, customized dependency library 414, to other systems. Application X 406 does not need to access other dependency files or libraries because all necessary files are contained in customized dependency library 414. Customized dependency library 414 may be linked and stored so that as application X 406 is added to a client system, the customized dependency library 414 is linked for immediate usage and reference by application X 406.

As a result, the footprint of customized dependency library 414 as loaded onto a client system may be much smaller than that of dependency repository 404. The footprint refers to the system resources that are used to store, process, and maintain customized dependency library 414. The footprint is especially important on devices, such as personal digital assistants, cell phones, and other computing devices with limited resources.

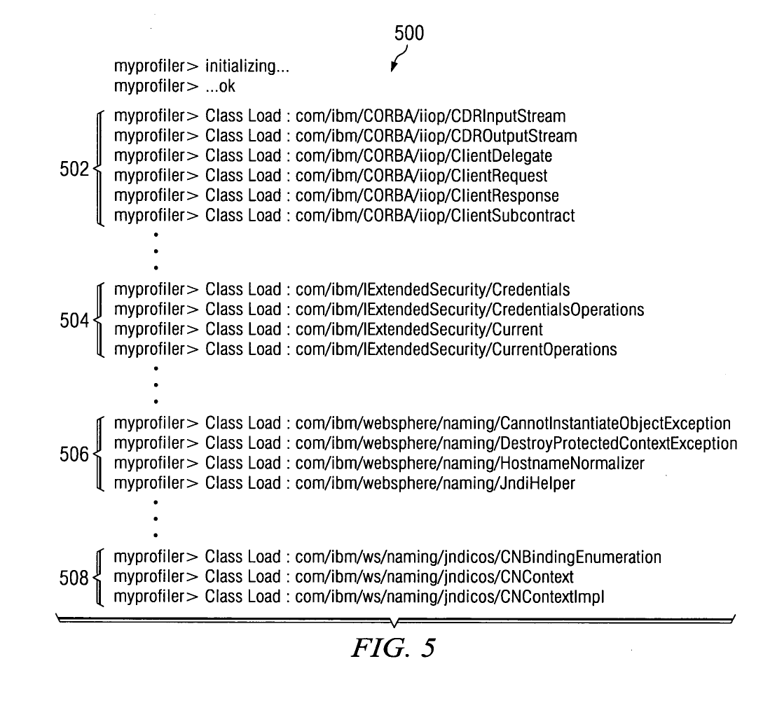

FIG. 5 is a dependency list in accordance with an illustrative embodiment of the present invention. Dependency list 500 may be a dependency list created by a profiler such as dependency list 410 and profiler 402 of FIG. 4, respectively. Dependency list 500 lists all of the dependencies or classes loaded in order to properly execute a client application such as application X 406 of FIG. 4.

Dependency list 500 may be created during development of the client application. For example, new classes may be added to dependency list 500 in phases as the client application is developed. Section 502, section 504, section 506, and section 508 may be added separately during testing or development to form dependency list 500 listing all of the client application's dependencies. Using dependency list 500, a full dependency library may be accessed to form a customized dependency library such as customized dependency library 414 of FIG. 4.

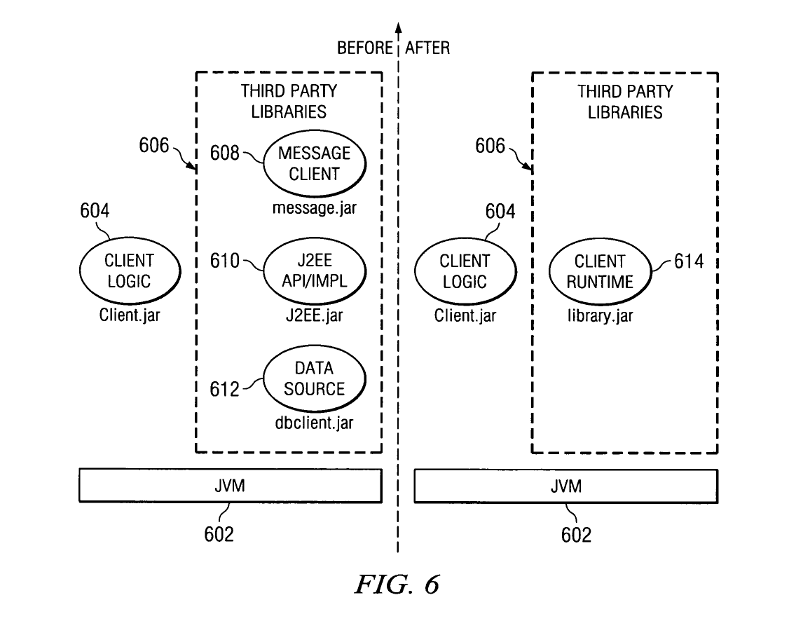

FIG. 6 is a pictorial representation of a dependency packaging system before and after implementing the processes in accordance with an illustrative embodiment of the present invention. Java virtual machine 602 may be a Java virtual machine such as Java virtual machine 304 of FIG. 3. A Java™ client application usually consists of application logic such as client logic 604, which may be packaged in a Java™.jar file named client.jar. The Java™ client application may be an application such as application X 306 of FIG. 3.

Before the third party libraries are customized to include the dependencies required for client logic 604, third party libraries 606 may include any number of files, classes, and other dependencies. For example, third party libraries may include message client 608 named message.jar, J2EE Api/Impl 610 named J2EE.jar, and data source 612 named dbclient.jar.

After implementing dependency packaging, third party libraries are customized to only include the dependencies required by client logic 604. In this illustrative example, client runtime 614 named library.jar includes only the specific dependencies required for execution of all scenarios of client logic 604 instead of all of dependencies included in third party libraries 606.

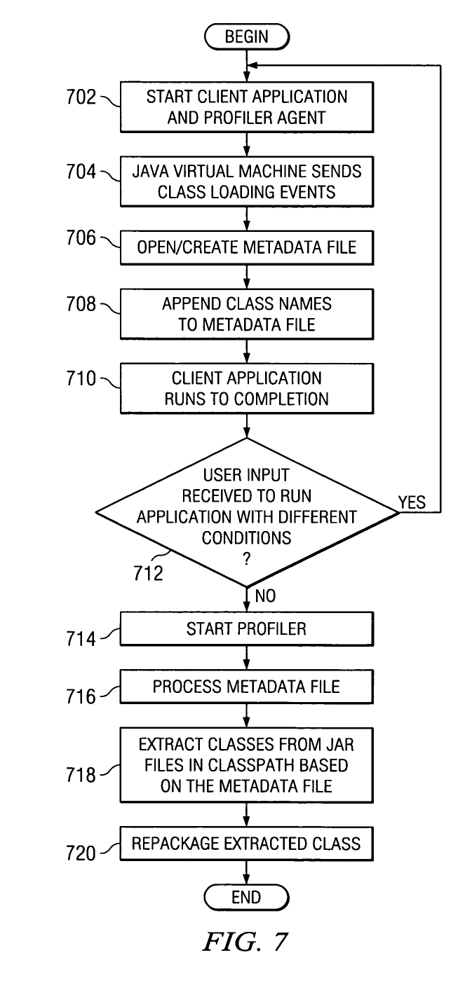

FIG. 7 is a flowchart of a process for dependency packaging in accordance with an illustrative embodiment of the present invention. The process of FIG. 7 may be implemented in a Java™-based system such as Java™-based system 300 of FIG. 3 and more specifically implemented by components of a profiler such as profiler 312 of FIG. 3. The process may receive external user input if the user wants to change conditions or configurations so that other dependencies are invoked.

The process begins by launching the client application with the profiler agent (step 702). The profiler and Java™ application may be a profiler, profiler agent, and application such as profiler 402, profiler agent 408, and application X 406 of FIG. 4. Step 702 may include specifying the third party's libraries in the “-classpath” Java™ command argument. The profiler agent may be implemented as native library, such as myprofile.dll. The location is specified in the operating system PATH environment variable so that the Java virtual machine may locate the myprofile.dll in order to start the profiler agent. For example, the command argument may be java-Xrunmyprofiler-classpath list_of_third_party_libraries application_main_class.

Next, the Java virtual machine sends class loading events to the profiler agent (step 704). The Java virtual machine may be a Java virtual machine such as Java virtual machine 304 of FIG. 3. As part of step 704, the Java virtual machine loads the application main class from the application library, such as myclient.jar. A “class load” event notice is sent to the profiler agent as triggered by loading the main into the Java virtual machine. As the application continues to execute, more classes are loaded into the Java virtual machine and the corresponding class load event is sent to the profiler agent.

The profiler agent opens or creates a metadata file (step 706). The metadata file may be a dependency list such as dependency list 410 of FIG. 4. In step 706, the profiler agent creates a metadata file if the metadata file is not yet created. If the metadata file exists, the profiler agent opens the metadata file for dependency updates.

Next, the profiler agent receives the class load events and appends the class name to the metadata file (step 708). The client application runs to completion (step 710). At completion the client application closes down and the profiler agent closes the metadata file and exits the Java virtual machine.

Next, user input is received specifying whether to run the application with different conditions (step 712). If the user decides to run the client application with different conditions, the process launching the client application with the profiler agent (step 702) is then restarted. The process restarts because different conditions may be used that may affect the classes accessed by the profiler in responding to other scenarios, settings, hardware, errors, or other system configurations or changes. For example, if the client application is unable to contact a service for a service request, the client application may run through the error handling path which may cause extra classes to be loaded. In this example, the user may determine whether to include the error exception classes and/or error message resource bundle classes that are required to resolve this type of error.

If the user decides not to run the client application with different conditions, the process starts the profiler (step 714). The profiler may use a profiler agent for monitoring and recording dependencies and a dependency generator to process dependencies and generate a customized dependency library. The profiler may be started with the same -classpath command argument used in step 702. Next, the profiler processes the metadata file (step 716). During processing the profiler may eliminate duplicate classes and Java™ core runtime classes. The profiler extracts classes from .jar files in the classpath based on the metadata file (step 718). Step 718 may be performed by a dependency generator such as dependency generator 412 of FIG. 4. The jar files may be stored in a repository such as dependency repository of FIG. 4. Dependency generator may search for the classes listed in the metadata file and then extract them from the packaged jar files in the classpath environment. The extracted classes may be temporarily stored to a location.

The profiler repackages all the extracted class into a single jar file (step 720), such as client runtime 614 named library.jar of FIG. 6. The newly created library.jar is a much smaller library that has been optimized and customized. The new file is smaller than the sum of all of the third party libraries that may have been available to client application. The specific library file, library.jar, may be physically stored and linked with the application the library.jar file was created for. As a result, the application and specific library may be loaded onto other computing devices and systems easily and efficiently. In one example, the Java™ command to start the client application with the single optimized library is Java™-classpath library.jar application_main_class.

Aspects of the present invention allow a single dependency library to be automatically created for a client application from a full dependency library. No trial-and-error process is required. The client application need only run through all user scenarios so that the dependencies may be recorded in a dependency list. The dependency list is used to extract the necessary dependencies from the full dependency library to generate a customized dependency library. The client application and customized dependency library may be loaded to other client systems so that the client system may run independently with a minimal footprint.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for generating a customized dependency library for use by an application, the computer implemented method comprising:
monitoring execution of the application;
identifying dependencies used by the application during execution of the application; and
generating the customized dependency library for the application containing only the dependencies used by the application.

2. The computer implemented method of claim 1, wherein the monitoring step comprises:
initiating execution of the application;
running all desired scenarios of the application to invoke associated dependencies of the application; and
recording each dependency used as the dependencies are loaded into the application from a dependency repository.

3. The computer implemented method of claim 2, wherein the generating step comprises:
extracting the dependencies recorded from the dependency repository to form the customized dependency library.

4. The computer implemented method of claim 1, wherein the application is an application that executes code that is non-specific or non-native to a processor.

5. The computer implemented method of claim 1, wherein the steps are implemented in a profiler.

6. The computer implemented method of claim 1, further comprising storing the customized dependency library for use by the application.

7. The computer implemented method of claim 1, further comprising linking the customized dependency library to the application.

8. The computer implemented method of claim 1, wherein the method steps of claim 1 are performed during application development.

9. The computer implemented method of claim 1, wherein the dependencies are at least one of libraries, objects, classes, program code, and sections of program code.

10. The computer implemented method of claim 2, wherein the dependencies recorded are stored in a computer usable file.

11. The computer implemented method of claim 1, wherein the generating step further comprises:
logging an identification for each of the dependencies in the computer usable file.

12. The computer implemented method of claim 11, wherein the identification is any of a name, call, link, or location.

13. The computer implemented method of claim 1, further comprising:
deploying the application and the customized dependency library to a plurality of systems.

14. The computer implemented method of claim 1, wherein the customized dependency library is a .jar file.

15. The computer implemented method of claim 2, where in the extracting step comprise:
eliminating duplicate dependencies so that only one of each dependency is saved in the customized dependency library.

16. A system comprising:
a dependency repository;
a processor operably connected to the dependency repository for processing an application, an operating system, and a profiler, wherein all desirable scenarios of the application are run; and
a storage device operably connected to the processor for storing the operating system, and the application, wherein the profiler monitors execution of the application, identifies dependencies used by the application during execution of the application, and generates a customized dependency library for the application containing only the dependencies used by the application, and stores the customized dependency library on the storage device.

17. The system of claim 16, wherein the application is run by a Java virtual machine and the profiler monitors execution of the application using a Java virtual machine profiler interface.

18. A computer program product comprising a computer usable medium including computer usable program code for generating a customized dependency library for use by an application, said computer program product including:
computer usable program code for monitoring execution of the application;
computer usable program code for identifying dependencies used by the application during execution of the application; and
computer usable program code for generating the customized dependency library for the application containing only the dependencies used by the application.

19. The computer program product of claim 18, further comprising:
computer usable program code for initiating execution of the application;
computer usable program code for running all desirable scenarios of the application for invoking dependencies of the application;
computer usable program code for recording each dependency used as the dependencies are loaded into the application from a dependency repository;
computer usable program code for eliminating duplicate dependencies;
computer usable program code for extracting the dependencies from the dependency repository based on the dependencies recorded to form the customized dependency library; and
computer usable program code for storing the customized dependency library for use by the application and linking the customized dependency library to the application.

20. The computer program product of claim 18, further comprising:
computer usable program code for deploying the application and the customized dependency library to a plurality of systems.
